(19) United States
(12) Patent Application Publication
(10) Pub. No.: US 2011/0247224 A1
(43) Pub. Date: Oct. 13, 2011

(54) CABLE SAW SYSTEM

(75) Inventor: Hector R. Hernandez, Fullerton, CA (US)

(73) Assignee: ALLTRADE TOOLS LLC, Long Beach, CA (US)

(21) Appl. No.: 12/757,781

(22) Filed: Apr. 9, 2010

(51) Int. Cl. B23D 53/12; B23D 55/10; B23D 55/00

(52) U.S. Cl. 30/394; 30/517; 30/513

(57) ABSTRACT

A cable saw system is described comprising a cable saw blade, a forward handle removably connected to a forward end of the blade, a rearward handle removably connected to a rearward end of the blade. A motor mounted in the rearward handle. A forward block is configured to removably receive the forward handle, and a rearward block spaced apart from the forward block and configured to removably receive the rearward handle. A threaded dowel connects the forward block to the rearward block, the threaded dowel being configured to be rotatable to adjust the spacing between the forward block and the rearward block and thereby to adjust tension in the blade. The forward handle and the rearward handle are removable from the forward block and the rearward block so that the handles are capable of manipulation to apply a force between the blade and an object-to-be-cut, and when the forward handle and the rearward handle are received by the forward block and the rearward block, a force is applicable between the blade and an object-to-be-cut, and the tension in the blade is adjustable by rotating the dowel.

### BACKGROUND

The present invention relates to a cable saw for cutting objects having an irregular shape. Specifically, the invention is directed to a cable saw having a versatile and adjustable configuration.

Cable saws are known in the art for manually cutting cylindrical objects like pipes, tree stumps, or bars. Typically, a cable saw comprises a flexible blade made of a flexible element such as rope or cable, on which there is embedded or affixed a grit or carborundum that adds a cutting capability to the flexible element. A user grasps both ends of the flexible element, using handles that may be attached to each end, wraps the flexible element around the object-to-be-cut, and pulls alternatingly one end and then the other. This action causes the flexible blade to reciprocate back and forth while in contact with the object-to-be-cut, and the action slowly cuts through the object. Cable saws are thus typically light and inexpensive because they consist essentially of the flexible blade with rudimentary handles. One reason that a cable saw may be used instead of, say, a regular saw is that a user may apply a very large force between the flexible blade of a cable saw and the object-to-be-cut. The flexibility of the blade allows the user to wind the blade around the object-to-be-cut so that it turns double back upon itself at 180 degrees, while the object is positioned inside the turning point. If the user leans rearwards while holding the handles of the blade, he may exert the full force of his weight between the blade and the object. This is much larger than the force a user may apply between a regular saw and the object-to-be-cut, where the user stands alongside the saw and cannot lean his weight into it. Thus, cable saws occupy a useful place in the tool kit of a workman because they may have an affect that no other tool can ordinarily achieve.

However, there are shortcomings in the art of cable saws. First, the human energy required to power a chain saw is considerable, and there exists a need to provide assistance to a workman using a chainsaw. Second, it is frequently desirable to use a cable saw to cut an object from one side of the object only. That is to say, it is undesirable to wrap the blade around the object by 180 degrees, but rather to extend the blade in a linear fashion across one side of the object only. In these circumstances, it is difficult and uncomfortable for the user to apply a substantial force to the blade because he is effectively obliged to pull the handles of the blade apart from each other to impart a substantially straight line shape to the blade. In these conditions, it is also difficult for the user to maintain a substantial tension in the blade, and it is uncomfortable to apply a reciprocating force to the blade.

Accordingly, there is a need in the prior art for a cable saw that solves the problems of the prior art. The present invention addresses these and other needs.

### SUMMARY OF THE INVENTION

In one preferred embodiment, the invention is a cable saw system comprising a cable saw blade, a forward handle removably connected to a forward end of the blade, and a rearward handle removably connected to a rearward end of the blade. A motor is mounted in the rearward handle, the motor having a flywheel and a cam rod configured to apply a reciprocating motion to the blade. A spring is positioned in the forward handle configured to maintain tension in the blade when the cable saw blade undergoes reciprocation. A forward block is provided, configured to removably receive the forward handle. A rearward block is provided, spaced apart from the forward block and configured to removably receive the rearward handle. Under this structure, the forward block and the rearward block have interlinking structure configured to hold the forward block in registration with the rearward block and to permit the forward block to slide towards and away from the rearward block. A threaded dowel is provided, connecting the forward block to the rearward block, the threaded dowel being configured to be rotatable to adjust the spacing between the forward block and the rearward block and thereby to adjust tension in the blade. Under this configuration, the forward handle and the rearward handle are removable from the forward block and the rearward block so that the handles are capable of manipulation to apply a force between the blade and an object-to-be-cut. In a preferred aspect, when the forward handle and the rearward handle are received by the forward block and the rearward block, a force is applicable between the blade and an object-to-be-cut, and the tension in the blade is adjustable by rotating the dowel.

In another aspect of the invention, the interlinking structure includes an opening on one of the forward block or the rearward block, and further includes an arm on the other of the forward block or the rearward block, the arm being sized to slide in the opening. Again preferred, the forward block includes a narrowed passage that allows a narrow portion of the forward handle to pass through, but is too narrow to allow passage of a broader portion of the forward handle. Also preferred, the rearward block includes a narrowed passage that allows a narrow portion of the rearward handle to pass through, but is too narrow to allow passage of a broader portion of the rearward handle. An aspect of the invention is that the blade is sufficiently flexible to be bent in a turn of 180 degrees, and to be used for cutting while bent in a turn of 180 degrees.

In a second preferred embodiment, the invention is a cable saw system comprising a cable saw blade, a forward handle removably connected to a forward end of the blade, and a rearward handle removably connected to a rearward end of the blade. A motor is mounted in the rearward handle, the motor having a flywheel and a cam rod configured to apply a reciprocating motion to the blade. A first spring is attached between the forward handle and the blade, the first spring being configured to maintain tension in the blade when the cable saw blade undergoes reciprocation. In this embodiment, the first spring is located outside the forward handle, thus imparting a high degree of free movement to the spring. In a further aspect, the cable saw of this embodiment includes a spacer assembly configured to apply tension to the blade. The spacer assembly has a first arm configured to removably receive the rearward handle, and a second arm configured to removably receive the forward handle. The second arm is pinned to the first arm, and the first and second arms are urged apart by a second spring, thereby applying tension to the blade. Further preferred, the rearward handle includes a third spring positioned between the blade and the rearward handle, and connecting the blade to the rearward handle. The first spring has a first modulus of elasticity, and the third spring has a second modulus of elasticity, wherein the second modulus is greater than the first modulus. Under this arrangement of differing moduli of elasticity, the cable saw is able to operate with the first spring absorbing the motion of the blade. If the blade should become stuck in the object-being-cut, then the third spring is able to absorb the oscillating motion of the motor, tending to preserve the blade from being snapped.

These and other aspects of the invention may be better understood with reference to the brief description of the drawings, and the detailed description of the preferred embodiments, that follow.

### BRIEF DESCRIPTION OF THE DRAWINGS

FIG. 1 a perspective view of a first embodiment of a cable saw system having features of the present invention.

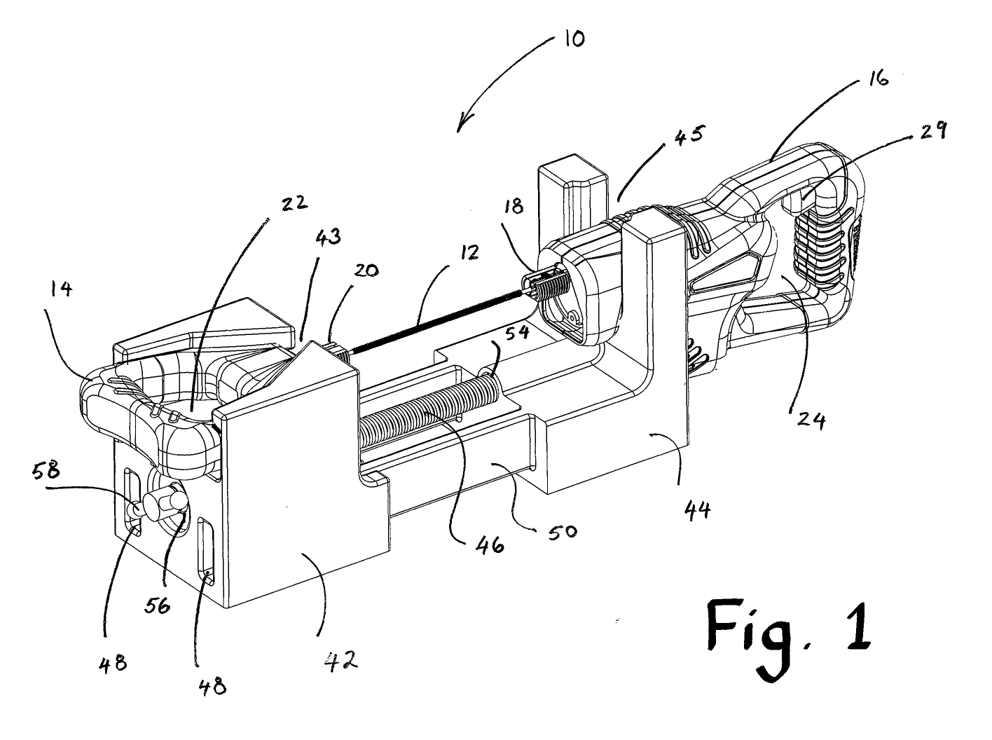

FIG. 2 is an exploded perspective view of some of the components of the cable saw system of FIG. 1.

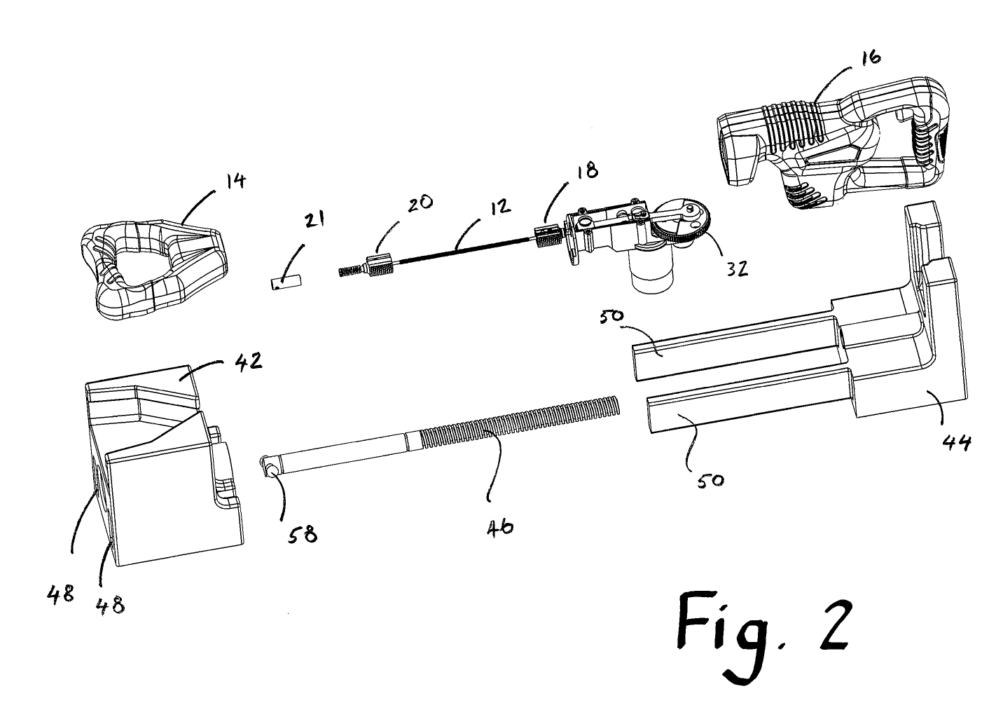

FIG. 3 is a detail perspective view of a portion of FIG. 3.

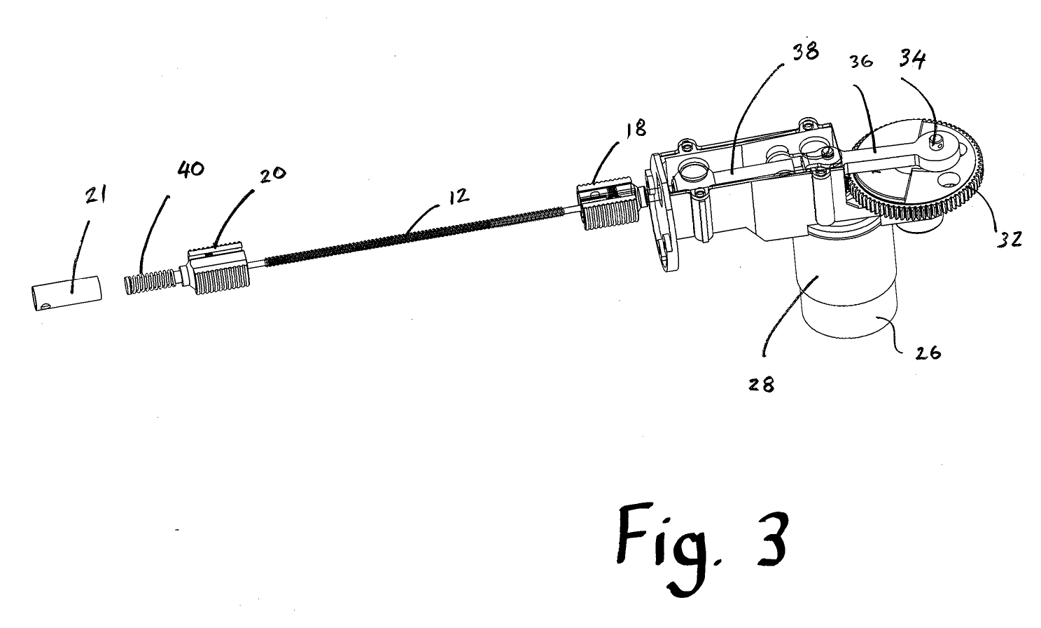

FIG. 4 is a sectional side view of the cable saw system of FIG. 1.

FIG. 5 is a perspective view of a second embodiment of a cable saw having features of the present invention.

### DETAILED DESCRIPTION OF THE PREFERRED EMBODIMENTS

With reference to the drawings, which are disclosed for exemplification and not for limitation, there is described a cable saw system 10 having features of the present invention.

The invention comprises a flexible blade 12, known in the art, comprising a rope, chain, or cable that has cutting elements such as grit or carborundum embedded or attached to facilitate cutting an object when the blade 12 is drawn past the object while in contact with the object. The blade is held at opposite ends by holders 18, 20 which are configured to permit removal and replacement of the blade 12 in relation to the system 10. At either end of the blade the holders are embedded in a forward handle 14 and a rearward handle 16.

The forward handle and the rearward handle each has an opening 22 and 24 respectively for receiving the hand of a user. The blade is sufficiently flexible that it may be bent in a turn of 180 degrees, and may be used for cutting while bent in a turn of 180 degrees. A user may alternately or reciprocatingly pull each handle 14, 16 so that, if the blade 12 is wrapped around an object (not shown) that is positioned within the turn of the blade, the blade will repeatedly cut into the object. In one aspect of the present invention, a user may manipulate the blade 12 by reciprocatingly moving the handles 14, 16 with his hands.

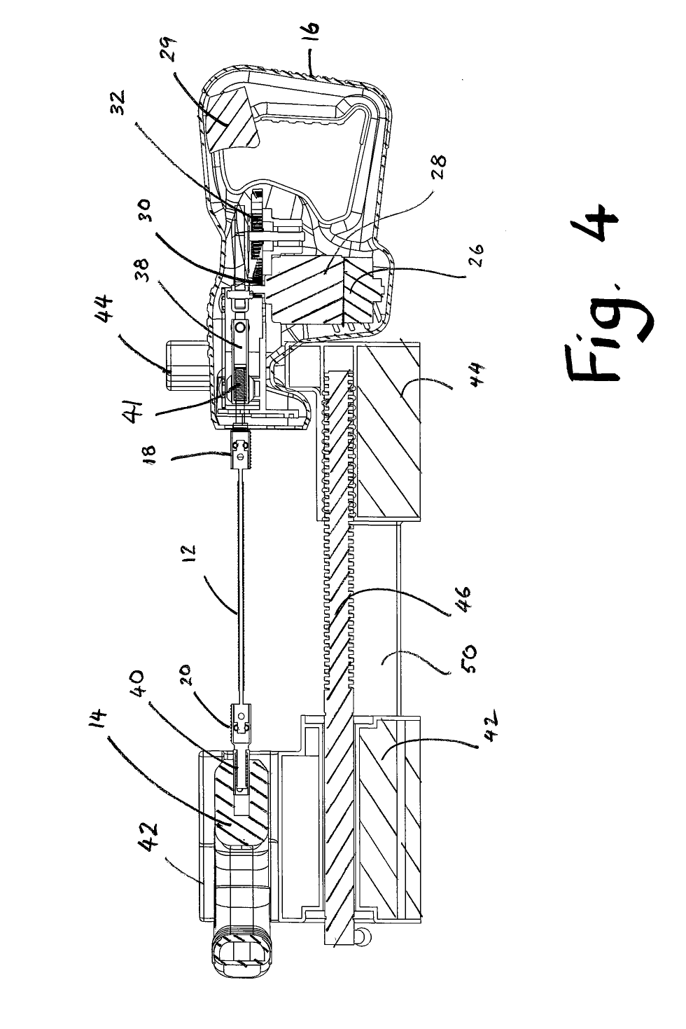

In another aspect of the invention, the rearward handle is provided with an electric power supply. Preferably, the power supply is a rechargeable battery 26, although in another preferred embodiment the power supply may be supplied by electric cable (not shown). In conjunction with the power supply 26, a motor 28 is provided that is activatable by a trigger 29. The motor rotates a toothed drive wheel 30 (FIG. 4) which in turn rotates a toothed flywheel 32 under a large mechanical advantage. Positioned at an eccentric location on the flywheel is a pin 34 to which is pinned a cam rod 36. A pull rod 38 is jointedly connected to the cam rod 36. The pull rod is connected to the connector 18 holding the blade. Thus, rotation of the flywheel causes the pin 32 to rotate about the axis of the flywheel 32, thereby to oscillate the cam rod 36, thereby to reciprocate the pull rod 38, and thereby to reciprocate the blade 10 via the rearward connector 18.

On the forward end of the blade 12, the forward connector 20 may be attached to a first helical return spring 40 which is in turn connected to the forward handle via a connector cylinder 21. When the blade is held in a taught condition, the rearward reciprocation of the pull rod 38 pulls on the blade 10, which pulls on the first return spring 40 and extends the return spring while the blade 10 moves rearwardly. When the pull rod 38 reciprocates forwardly upon rotation of the flywheel 32, the return spring 40 contracts to maintain the blade 10 in tension, and moves the blade forwardly, thus imparting a rearward and forward motion to the blade. If the blade is wrapped around an object so that the blade returns on itself at 180 degrees, the rearward and forward motion of the blade will not be fundamentally altered. Indeed, the blade may assume any turn angle between zero degrees and 180 degrees while it is being used to cut an object, and the reciprocating action of the blade will be substantially maintained, although, as it will be appreciated, the motion of the blade will follow its bent path rather than a linear path. Thus, in a further aspect of the invention, the blade may be reciprocated back and forth under motor power while wrapped or partially wrapped around an object.

In another aspect of the invention, the rearward connector 18 may be attached to a second helical spring 41 (seen in FIG. 4) having a larger elastic modulus than the first return spring 40. The second return spring 41 is in turn connected to the rearward handle via pull rod 38. Where a second return spring 41 is included, the second return spring may act as failsafe, so that if the blade 12 becomes stuck in an object-being-cut, the action of the pull rod 38 does not incline to snap the blade, but the second return spring allows the pull rod 38 to oscillate without damage to the blade. It will be appreciated that the elastic modulus of each return spring must be selected so that the modulus of the second spring 41 is much larger than that of the first return spring 40, so as to permit the blade to oscillate under normal working conditions, without all the oscillation of the pull rod 38 being absorbed by the second return spring 41. If this were to happen, it may leave the blade stationary, or near stationary, and the chain saw would be ineffective.

In yet a further aspect of the invention, the system 10 may be selectively configured to maintain a substantially linear configuration of the blade 12 during use. This aspect of the invention is particularly advantageous when working in an environment that does not permit the user to wrap the blade around an object-to-be-cut. This may arise for example when a user cannot get the blade around the side of the object opposite to his own location, but can only gain access to the object-to-be-cut from the same side that he is located. In this situation, it is extremely difficult to apply any tension to the blade using one's hands, because it is necessary to pull the handles 14, 16 apart from each other. The human body can pull objects apart for only short periods of time before coming weary, and this is particularly true when one is simultaneous trying to apply a force perpendicular to the pulling action, against an object.

Thus, the present invention provides a support system comprising two support blocks that are interconnectable. A forward support block 42 is configured to grasp the forward handle 14 and prevent it from moving rearwardly. A rearward support block 44 is configured to grasp the rearward handle 16 and prevent it from moving forwardly. The grasping feature of the forward block and the rearward block preferably comprise a narrowed passage 43 and 45 respectively on each block that allows a narrow portion of each handle to pass through, but is too narrow to allow passage of a broader portion of each handle. Each block is configured to cooperate with the other so as to maintain a steady and unmoving alignment with the axis of the blade. To this end, the forward block includes at least one cylindrical opening 48 extending parallel with the axis of the blade 10, and the rearward block includes at least one cylindrical arm 50 extending parallel with the axis of the blade. The arm 50 is configured to slide snugly through the opening 48 so that the two blocks are obliged to move in relation to each other along the axis of the blade. Further, a threaded dowel 46 is provided. The dowel is screwed into a threaded hole 54 extending in the rearward block parallel with the blade 10. A forward end of the dowel passes through an opening 56 in the forward block 42. The forward tip of the dowel carries a T-piece 58 that is sized to not pass through the opening 56. By rotating the T-piece, the user may advance or withdraw the forward block 42 in relation to the rearward block 44 and thereby increase or diminish the space between each block. Thus, once the handles 14, 16 holding the blade 10 are captured by the narrow passages 43, 45 of each block 42, 44, a user may apply more or less tension to the blade by enlarging or diminishing the space between the two blocks by rotating the T-piece 58 of the threaded dowel 46.

This aspect of the invention provides a novel and advantageous feature to the user, who may now approach an object that denies access on a side opposite the user, but allows access on a side closest to the user. In these circumstances, the user may mount the handles 14, 16 in the interconnected support blocks 42, 44, by placing the handles in the narrowed passages 43, 45 of each handle. The user may then tension the blade 10 to a desired tension by rotating the T-piece 58 of the threaded dowel 46. The user may then press the blade 12 up against the object-to-be-cut by manipulating the support blocks 42, 44. He may activate the motor 28 using the trigger 29 and allow the blade to reciprocate across the object while easily leaning into the blocks and applying the full force of his leaning weight between the blade 10 and the object-to-be-cut.

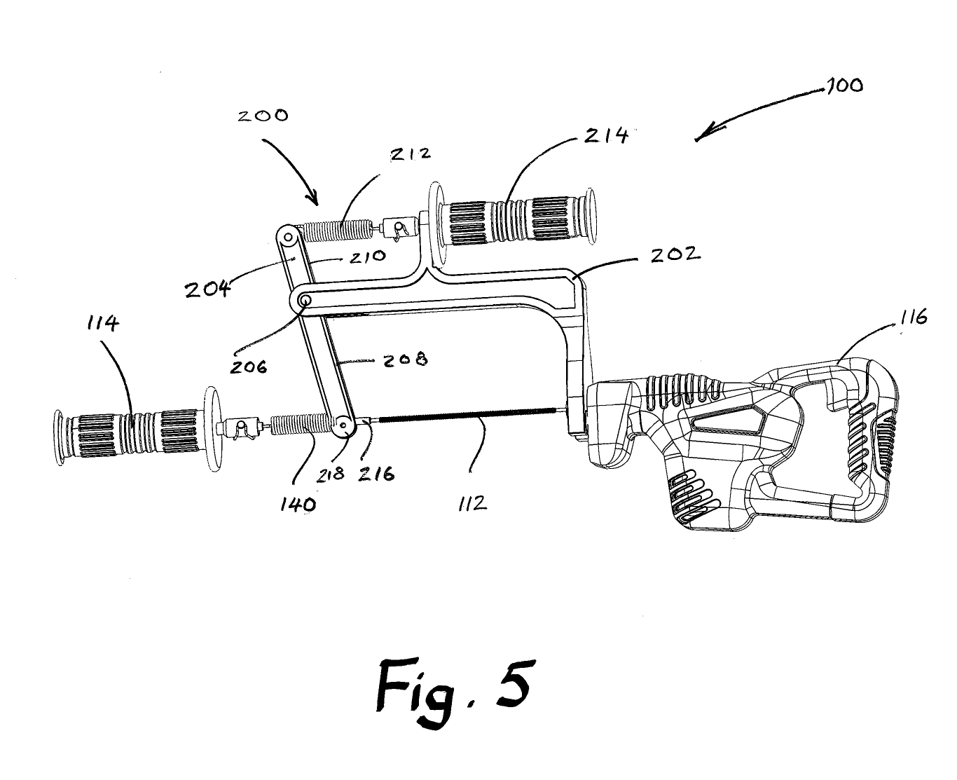

In a second embodiment of the invention, a cable saw generally referred to by numeral 110 is described with reference to FIG. 5. This embodiment includes a rearward handle 116 that has a similar configuration to the rearward handle as in the previous embodiment, and may include a second return spring (not shown in FIG. 5). It includes a forward handle 114 that may assume a similar configuration to the forward handle of the previous embodiment, or it may have variations. For example, the forward handle 114 of the present embodiment has a first return spring 140 that is located outside of the handle housing, as shown. This aspect has an added advantage when the cable saw is being used without a spacer assembly maintaining separation between the forward handle and the backward handle. The fact that the forward spring 140 is external to the handle gives a user more freedom to rotate the forward handle 114 in relation to the axis of the blade 112, because the spring 140 itself is able to twist and turn, and absorbs variations in tension in the blade with less stress being placed on the blade due to elimination of sharp corners being imposed on the blade.

Of significant difference, the system for maintaining tension in the blade 112 of the present invention allows for a non-rigid spacing configuration. In this embodiment, a spacer assembly 200 is provided to urge the forward handle 114 and the rearward handle 116 apart from each other during operation. The spacer assembly 200 includes a first arm 202 that is configured to allow the blade 112 to slidingly pass through the arm, but to restrain the rearward handle 116 from movement in relation to the arm 202. The assembly 200 includes a second arm 204 that is preferably configured to capture the forward end 216 of the blade and prevent the blade from sliding through the second arm 204.

Significantly, the first arm 202 and second arm 204 are connected to each other by a pin connection 206, which allows the second arm 204 to pivot about a point on the first arm 202. The pivotable second arm is divided by the pivot 206 into a lower lever arm 208 and an upper lever arm 210. The terminal end 218 of the lower lever arm 208 receives the blade 112, while the terminal end of the upper lever arm 204 is connected to a tensioning spring 212. The tensioning spring 212 may be adjusted in length by a rotatable handle or knob 214. Thus, when the present embodiment is being readied to cut an object, the force delivered by the tensioning spring 212 may be adjusted to set the desired tension in the blade 112 via the pivoting second arm 204. Thus, when the entire cable saw 100 including the spacing assembly 200 is applied to cutting an object, in a manner analogous to the first embodiment above, a user may gain access to objects for cutting that would otherwise be difficult to cut without the spacer assembly maintaining tension in the blade 112. Further, the spacer assembly of this embodiment allows a greater range of adjustability of the tension in the blade, and does not rely on the forward return spring 140 to provide that flexibility. And yet further, the tensioning spring 212 may absorb sudden shocks, via the second arm 204, during operation of the blade, thus providing an added safety feature to the assembly 100.

Thus, the present invention addresses with novel and useful features certain needs that are found in the art. The present invention may, of course, be carried out in other specific ways than those herein set forth without departing from the essential characteristics of the invention. The present embodiments are, therefore, to be considered in all respects as illustrative and not restrictive, while the scope of the invention is set forth in the claims that follow.

I claim:

1. A cable saw system comprising:
a cable saw blade;
a forward handle removably connected to a forward end of the blade,
a rearward handle removably connected to a rearward end of the blade;
a motor mounted in the rearward handle, the motor having a flywheel and a cam rod configured to apply a reciprocating motion to the blade;
a spring in the forward handle configured to maintain tension in the blade when the cable saw blade undergoes reciprocation;
a forward block configured to removably receive the forward handle, and a rearward block spaced apart from the forward block and configured to removably receive the rearward handle, wherein the forward block and the rearward block have interlinking structure configured to hold the forward block in registration with the rearward block and to permit the forward block to slide towards and away from the rearward block;
a threaded dowel connecting the forward block to the rearward block, the threaded dowel being configured to be rotatable to adjust the spacing between the forward block and the rearward block and thereby to adjust tension in the blade;
whereby the forward handle and the rearward handle are removable from the forward block and the rearward block so that the handles are capable of manipulation to apply a force between the blade and an object-to-be-cut; and
further whereby, when the forward handle and the rearward handle are received by the forward block and the rearward block, a force is applicable between the blade and an object-to-be-cut, and the tension in the blade is adjustable by rotating the dowel.

2. The cable saw system of claim 1, wherein the interlinking structure includes an opening on one of the forward block or the rearward block, and further includes an arm on the other of the forward block or the rearward block, the arm being sized to slide in the opening.

3. The cable saw system of claim 1, wherein the forward block includes a narrowed passage that allows a narrow portion of the forward handle to pass through, but is too narrow to allow passage of a broader portion of the forward handle.

4. The cable saw system of claim 1, wherein the rearward block includes a narrowed passage that allows a narrow portion of the rearward handle to pass through, but is too narrow to allow passage of a broader portion of the rearward handle.

5. The cable saw system of claim 1, wherein the forward handle includes an opening for receiving the hand of a user.

6. The cable saw system of claim 1, wherein the rearward handle includes an opening for receiving the hand of a user.

7. The cable saw system of claim 1, wherein the blade is sufficiently flexible to be bent in a turn of 180 degrees, and to be used for cutting while bent in a turn of 180 degrees.

8. A cable saw system comprising:
a cable saw blade;
a forward handle removably connected to a forward end of the blade,
a rearward handle removably connected to a rearward end of the blade;
a motor mounted in the rearward handle, the motor having a flywheel and a cam rod configured to apply a reciprocating motion to the blade;
a first spring attached to the forward handle and to the blade, the first spring being configured to maintain tension in the blade when the cable saw blade undergoes reciprocation, the first spring being located outside the forward handle.

9. The cable saw system of claim 8, wherein the first spring is located outside the forward handle.

10. The cable saw system of claim 8, further including a spacer assembly configured to apply tension to the blade, the spacer assembly having a first arm configured to removably receive the rearward handle, and a second arm configured to removably receive the forward handle, wherein the second arm is pinned to the first arm, and the first and second arms are urged apart by a second spring, thereby to apply tension to the blade.

11. The cable saw system of claim 8, wherein the rearward handle includes a third spring attached to the blade.

12. The cable saw system of claim 11, wherein the first spring has a first modulus of elasticity, and the third spring has a second modulus of elasticity, wherein the second modulus is greater than the first modulus.

13. The cable saw system of claim 8, wherein the blade is sufficiently flexible to be bent in a turn of 180 degrees, and to be used for cutting while bent in a turn of 180 degrees.
